(19) United States
(12) Patent Application Publication
(10) Pub. No.: US 2024/0342761 A1
(43) Pub. Date: Oct. 17, 2024

(54) ELECTRICALLY OPERATED HIGH-PRESSURE CLEANING APPARATUS

(71) Applicant: ALFRED KÄRCHER SE & CO. KG, Winnenden (DE)

(72) Inventors: Sven DIRNBERGER, Winnenden (DE); Timo GEIGER, Winnenden (DE); Johannes RÖHRIG, Winnenden (DE)

(21) Appl. No.: 18/748,251

(22) Filed: Jun. 20, 2024

Related U.S. Application Data
(63) Continuation of application No. PCT/EP2021/087013, filed on Dec. 21, 2021.

(51) Int. Cl. B08B 3/02

(52) U.S. Cl. CPC B08B 3/026; B08B 2203/0223

(57) ABSTRACT

The invention relates to an electrically operated high-pressure cleaning apparatus, said cleaning apparatus comprising: a support device; an electric motor held thereon and/or arranged thereon; a pump which can be driven by the electric motor; and an electrical device; as well as a user-guided operating unit which can be or is connected to the pump via a high-pressure conduit, the electrical device comprising two connection lines via which the electric motor is connected or can be connected to a power supply device in a bipolar manner and can be supplied with electrical energy. In order to provide a high-pressure cleaning apparatus which is more user-friendly, in accordance with the invention: the electrical device comprises at least one switching element connected in at least one connection line, a control unit, and a first communication member; the operating unit comprises an actuating element and a second communication member for wirelessly transmitting a signal to the first communication member; and the control unit is operatively connected to the at least one switching element, and the at least one connection line is electrically conductively connected or electrically interrupted depending on an actuation of the actuating element.

### CROSS-REFERENCE TO RELATED APPLICATIONS

This application is a continuation patent application of international application number PCT/EP2021/087013, filed on Dec. 21, 2021, which is incorporated herein by reference in its entirety and for all purposes.

### FIELD OF THE INVENTION

The present invention relates to an electrically operated high-pressure cleaning apparatus comprising a support device, an electric motor held thereon and/or arranged thereon, a pump which can be driven by the electric motor, and an electrical device, as well as a user-guided operating unit which can be or is connected to the pump via a high-pressure conduit, the electrical device comprising two or more electrical connection lines via which the electric motor is connected or can be connected to a power supply device in a bipolar manner and can be supplied with electrical energy, a connection with more than two poles being conceivable.

### BACKGROUND OF THE INVENTION

With such a high-pressure cleaning apparatus, a cleaning liquid, in particular water, can be pressurized for cleaning purposes. A supply line is connected or can be connected to a pump inlet, for example. During operation of the high-pressure cleaning apparatus, the cleaning liquid is pressurized by means of the pump, for example an axial piston pump. During operation, the high-pressure conduit is connected to a pump outlet so that the pressurized cleaning liquid can be supplied to the operating unit. A release element, for example a hand-operated trigger, can be arranged on the operating unit and, when actuated, the cleaning liquid can be sprayed. The operating unit comprises or forms, for example, a so-called gun on which a spray lance for spraying the cleaning liquid can be arranged.

Two connection lines are provided via which the high-pressure cleaning apparatus is connected to the power supply device during operation in order to supply the electrical device with electrical energy. In this case, at least one bipolar connection is provided, although three-pole or multi-pole connections can be provided.

US 2016/0067726 A1 describes a high-pressure cleaning apparatus having an internal combustion engine or an electric motor. Sensors which detect the presence of hands on a handle and on a spray lance are arranged on the operating unit. When a hand-operated trigger is pulled, the internal combustion engine or the electric motor is switched on.

A high-pressure cleaning apparatus having an internal combustion engine that can be started and stopped via a radio remote control is disclosed in US 2020/0086357 A1.

DE 34 02 450 A1 describes a control circuit for a high-pressure cleaning apparatus. A pressure switch is provided which interrupts a current flow to the electric motor when the operating unit is inactive. In a further embodiment, an electrical supply line is interrupted by a timer after a predetermined period of inactivity has elapsed.

An object underlying the present invention is to provide a high-pressure cleaning apparatus of the type mentioned at the outset which is more user-friendly.

### SUMMARY OF THE INVENTION

In an aspect of the invention, an electrically operated high-pressure cleaning apparatus is provided. The apparatus comprises:
a support device,
an electric motor held thereon and/or arranged thereon,
a pump which can be driven by the electric motor,
an electrical device, and
a user-guided operating unit which can be or is connected to the pump via a high-pressure conduit.

The electrical device comprising two or more electrical connection lines via which the electric motor is connected or can be connected to a power supply device in a bipolar manner and can be supplied with electrical energy. The electrical device comprises at least one switching element connected in at least one connection line, a control unit, and a first communication member. The operating unit comprises an actuating element and a second communication member for wirelessly transmitting a signal to the first communication member. The control unit is operatively connected to the at least one switching element, and the at least one connection line is electrically conductively connected or electrically interrupted depending on the actuation of the actuating element.

### BRIEF DESCRIPTION OF THE DRAWINGS

The foregoing summary and the following description may be better understood in conjunction with the drawing figures, of which:

FIG. 1: shows a perspective schematic view of a high-pressure cleaning apparatus in accordance with the invention in a preferred embodiment; and

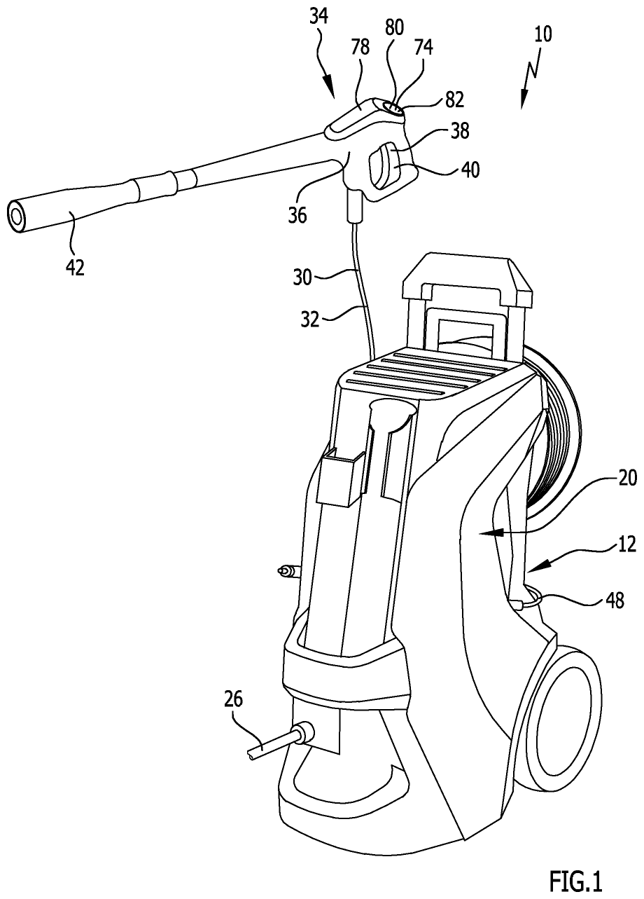

FIG. 2: shows a schematic block diagram of the high-pressure cleaning apparatus from FIG. 1.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to an electrically operated high-pressure cleaning apparatus. The apparatus comprises a support device, an electric motor held thereon and/or arranged thereon, a pump which can be driven by the electric motor, an electrical device, and a user-guided operating unit which can be or is connected to the pump via a high-pressure conduit. The electrical device comprising two or more electrical connection lines via which the electric motor is connected or can be connected to a power supply device in a bipolar manner and can be supplied with electrical energy. The electrical device comprises at least one switching element connected in at least one connection line, a control unit, and a first communication member. The operating unit comprises an actuating element and a second communication member for wirelessly transmitting a signal to the first communication member. The control unit is operatively connected to the at least one switching element, and the at least one connection line is electrically conductively connected or electrically interrupted depending on the actuation of the actuating element.

In the high-pressure cleaning apparatus in accordance with the invention, at least one connection line can be indirectly electrically conductively connected or electrically interrupted by the user via the actuating element arranged on the operating unit. This preferably allows the high-pressure cleaning apparatus to be connected or switched on ready for operation from the operating unit without this being present on the support device (which, for example, comprises or forms the housing of the high-pressure cleaning apparatus) when work is started or to be shut down when finished working. This is preferably also possible if the user is positioned spatially remotely from the high-pressure cleaning apparatus, for example when the high-pressure hose which forms the high-pressure conduit is unwound. For this purpose, in particular the wireless transmission of the signal via a radio connection between the communication members has proven to be advantageous. Wireless transmission is not dependent on a physical transmission channel. The advantages of the invention can therefore also be achieved, for example, if different types of high-pressure conduits are used with the high-pressure cleaning apparatus, for example high-pressure hoses of different lengths. Preferably, an operating element on the support device for switching on or connecting the high-pressure cleaning apparatus ready for operation and/or switching off the high-pressure cleaning apparatus can be dispensed with, which will be discussed below.

The connection lines can, for example, be stranded connection wires. A connection cable can comprise two or more connection lines, for example, for example with a plug for connection to a power supply network.

It goes without saying that the electrical device may not be completely de-energized when voltage is applied, by means of a mains connection and/or a battery of the high-pressure cleaning apparatus. For example, a current flow can be provided by the control unit, for example a control current. However, the at least one connection line is conductively connected via the switching element in such a way that the electric motor can be supplied with electrical energy by current flow, for example a power current, or electrically interrupted in order to prevent the current flow.

With regard to a reliable communication connection between the communication members, it is advantageous, for example, if a unique identification is possible among the communication members. Any identification tags are already stored in the communication members by the manufacturer, for example, and already linked to one another (pairing). Alternatively or additionally, a link may be possible and/or required by a user before startup or during operation of the high-pressure cleaning apparatus. The identification tags can be MAC addresses of the communication members, for example.

The connection lines can be conductively connected and/or interrupted at least in a single pole via the switching element. It is conceivable that two or more poles and in particular all poles are connected.

In particular, it can be provided that the high-pressure cleaning apparatus is switched to a standby mode when the connection line is electrically conductively connected, the electric motor being switched on only when the user actuates a release element on the operating unit for spraying the cleaning liquid. In standby mode, the high-pressure cleaning apparatus is ready for operation, but the electric motor is not yet switched on. In the present preferred embodiment, this takes place only by actuating the release element, for example a hand-operated trigger on the operating unit. Depending on the actuation of the release element, a further connection line can for example be electrically conductively connected, for example via the pressure switch mentioned below, in order to allow current to flow through the electric motor.

A permanent radio connection can be provided between the communication members after the at least one connection line has been electrically conductively connected for the first time by actuating the actuating element and until the at least one connection line is electrically interrupted by actuating the actuating element. The radio connection can be established between the communication members, but can be configured to be passive in the absence of any actuation on the operating unit.

A radio connection between the communication members is, for example, Bluetooth-based, although other types of radio connections with which a person skilled in the art is familiar can alternatively or additionally be provided.

It is expedient in particular with regard to a simple structural configuration of the high-pressure cleaning apparatus that the electrical device does not comprise a further switching element connected in the at least one connection line in addition to the switching element that is operatively connected to the control unit.

It is advantageous if the high-pressure cleaning apparatus is void of an operating element on the support device for the user, in particular as a component of the electrical device in order to electrically conductively connect the at least one connection line. Accordingly, it can be provided that the actuating element on the operating unit forms the “main switch” for the user, via which the high-pressure cleaning apparatus is connected or switched on ready for operation. In contrast, no “main switch” is provided for the user on the support device, for example a housing, of the high-pressure cleaning apparatus in order to act on a switching element connected in at least one of the connection lines. The high-pressure cleaning apparatus thereby has a structurally simple configuration. After connecting the operating unit to the high-pressure conduit, coupling the high-pressure cleaning apparatus to the power supply device and connecting a supply line for the cleaning liquid, the high-pressure cleaning apparatus can be activated in a user-friendly manner via the operating unit, whereby the user can remain spatially remote from the support device.

It is clear from the above embodiments that, apart from the actuating element, the high-pressure cleaning apparatus advantageously does not comprise a further operating element—the “main switch” for the user, as it were—for switching on or connecting the high-pressure cleaning apparatus ready for operation and/or switching off the high-pressure cleaning apparatus.

The control unit is preferably galvanically isolated from the at least one connection line via the switching element.

In particular for the last-mentioned purpose, it can be provided, for example, that the switching element is or comprises a relay.

The signal transmitted from the second communication member to the first communication member can be a digital signal or an analog signal.

In a preferred embodiment, the signal is a pulse signal which may be digital (for example 0/1/0 for switching on and switching back off). In this way, a permanent radio signal can be dispensed with in order to minimize power consumption on the operating unit.

It is advantageous if, during operation of the high-pressure cleaning apparatus, the electrically conductively connected connection line can be monitored by the control unit for a current flow to the electric motor (for supplying said electric motor with power) and/or a voltage drop across the electric motor, and if an indication may be provided to the user at an indicating unit of the high-pressure cleaning apparatus, in particular a display unit, in the absence of a current flow and/or of a voltage drop. For example, the current flow and/or the voltage drop is checked at time intervals, in particular periodically, by the control unit and the connection line is thereby monitored. If no current is flowing or there is no voltage drop, the control unit may assume that there is a fault in the electrical device. An indication thereof can be provided via the indicating unit, in particular displayed on the display unit.

Alternatively or additionally, the high-pressure cleaning apparatus can be monitored during operation for the occurrence of a drop in pressure in the cleaning liquid, for example at a pressure chamber of the high-pressure pump or a pump outlet. For this purpose, the high-pressure cleaning apparatus can comprise, for example, a pressure sensor or a pressure switch. If there is a drop in pressure, the control unit can assume there is a fault. An indication thereof can be provided via the indicating unit, in particular displayed on the display unit.

The display unit can comprise a controllable image display.

It is advantageous if the operating unit comprises or forms the indicating unit and if a corresponding indication signal can be transmitted from the first communication member to the second communication member. This makes it possible to inform the user in a user-friendly manner on the control unit that no current is flowing and/or there is no voltage drop and/or that the cleaning liquid is not highly pressurized. The indication can in particular be or comprise a fault message which preferably suggests to the user possible steps to remedy the fault.

The actuating element can comprise or form the indicating unit.

It can be expedient for a test signal to be transmissible from the control unit, via the first communication member and to the second communication member when at least one connection line is electrically conductively connected and for a confirmation signal in response to the test signal to be transmissible from the second communication member to the first communication member, in the absence of which the connection line is electrically interrupted. If the control unit determines that no confirmation signal is received in response to the test signal, the control unit can assume that the radio connection to the operating unit has been interrupted or that it is not possible to establish the radio connection. For safety reasons, it is advantageous to electrically interrupt the connection line in this case and thereby to terminate operation of the high-pressure cleaning apparatus.

The test signal can preferably be repeatedly transmissible, in particular periodically. The connection line is preferably interrupted only after a predetermined number of absent confirmation signals or after a predetermined period of time has elapsed. This can prevent the high-pressure cleaning apparatus from being shut down if only one confirmation signal is absent, for example due to a temporary disruption in the radio connection.

In the context of the present patent application, “predetermined” can in particular also include “predeterminable”.

In practice, for example, it can prove to be advantageous if the connection line is electrically interrupted only after a period of several seconds during which no confirmation signal is received. For example, a period of time of approximately 2 s to 30 s is conceivable.

The test for current flow and/or voltage drop and/or pressure drop, and/or the transmission of the test signal can be carried out, for example, every second or sub-second.

The operating unit preferably comprises at least one battery, which can preferably be replaceable and/or rechargeable, for supplying power to the actuating element.

It is expedient if a charge level of the at least one battery can be displayed on an indicating unit of the operating unit, in particular a display unit, and/or an indication can be provided when the at least one battery falls below a predetermined charge level. In response to the charge level being displayed and/or indicated, the user can, for example, replace and/or charge the at least one battery. This ensures that the power supply for the actuating element is secured in order to ensure the switching behavior of the control unit desired by the user.

It can be provided, for example, that, when the actuating element is actuated, no signal is transmitted from the second communication member to the first communication member if the at least one battery has fallen below a predetermined charge level. In this case, the user should replace and/or charge the at least one battery in order to start up the high-pressure cleaning apparatus.

As already mentioned, the operating unit can comprise, for example, a release element, for example a hand-operated trigger. The operating unit for spraying the cleaning liquid can be activated via the release element. It is particularly expedient if the release element is different from the actuating element. For example, the high-pressure cleaning apparatus is switched to a standby mode by actuating the actuating element, whereby the electric motor has not yet been started, for example. The electric motor is started via the release element, for example using the pressure switch mentioned below, and cleaning liquid can be sprayed.

It can be advantageous if the high-pressure cleaning apparatus is completely or partially shut down when it is inactive. It is conceivable, for example, for a display unit of the operating unit or its background lighting to be switched off after approximately 3 minutes to 10 minutes of inactivity. For example, the high-pressure cleaning apparatus will be shut down after approximately 10 minutes to 30 minutes of inactivity.

For example, the control unit electrically interrupts the at least one connection line via the at least one switching element if a predetermined period of time within which the release element is not actuated has elapsed.

Alternatively or additionally, it can be provided that the at least one connection line to the electric motor is electrically interrupted if a predetermined period of time within which no current flow through the at least one connection line is detected has elapsed in order to supply the electric motor with electrical energy. As mentioned, provision can be made for electrical current to flow through the electrical device even if the connection line is interrupted, but no power current to the electric motor.

The high-pressure cleaning apparatus preferably comprises a pressure switch with which a pressure in the pump or downstream of the pump can be detected. For example, the pressure of the cleaning liquid is detected on or in a pump chamber of the pump to which the high-pressure conduit is connected during operation.

The pressure switch preferably comprises a further switching element or is operatively connected to such a switching element which is connected in one of the connection lines, the further switching element electrically conductively connecting the connection line when the pressure falls below a threshold pressure, and interrupting said connection line when the pressure reaches and/or exceeds the threshold pressure. The connection line for supplying electrical energy to the electric motor can be conductively connected via the pressure switch. For this purpose, the release element is actuated, for example, whereby the pressure drops below the threshold pressure and the electric motor is started up. If, in contrast, the release element is no longer actuated, the pressure increases to or above the threshold value, the electrical connection line is interrupted and the electric motor is set out of operation.

It can be provided that only one connection line (single-pole) is connected via the further switching element. Alternatively, a multi-pole circuit or an all-pole circuit of all the connection lines is conceivable.

In a preferred embodiment of the invention, the further switching element is connected in a different connection line than the switching element which is actuated depending on the actuation of the actuating element in the high-pressure cleaning apparatus in accordance with the invention. This provides the possibility of bipolar isolation, and in particular all-pole isolation, when two connection lines are present.

Dispensing with a “main switch” on the support device as described above has also proven to be advantageous for pressure switch-actuated high-pressure cleaning apparatuses. In conventional high-pressure cleaning apparatuses, the main switch on the housing of the high-pressure cleaning apparatus remains switched on even during work breaks. In the event of a leakage, this leads to a pressure drop and thus repeatedly causes the electric motor to start. This is undesirable because it places unnecessary strain on the electric motor and pump. In contrast, in a preferred embodiment of the high-pressure cleaning apparatus in accordance with the invention, the at least one connection line may be electrically interrupted as a result of inactivity. Even if the pressure drops due to a leakage, the electric motor is not started up by disconnecting one of the connection lines by means of the pressure switch, since there is at least single-pole isolation of the connection lines.

The high-pressure cleaning apparatus can be wired and have a connection cable comprising the connection lines. The connection cable can, for example, have a plug and can be plugged into a socket of the mains power supply device.

Alternatively or additionally, it can be provided that the high-pressure cleaning apparatus is battery-operated and has a receptacle for an electric battery that can be coupled to the connection lines.

As already mentioned, the high-pressure cleaning apparatus can comprise a housing. For example, the support device comprises a housing of the high-pressure cleaning apparatus in which the electric motor, the pump and, at least in part, the electrical device—for example except for portions of a possible connection cable—are accommodated.

The drawing shows a preferred embodiment of a high-pressure cleaning apparatus in accordance with the invention, which is denoted as a whole by reference numeral 10, for cleaning objects by a user (not shown in the drawing) handling the high-pressure cleaning apparatus 10.

The high-pressure cleaning apparatus 10 comprises a support device 12, an electric motor 14 arranged thereon, a pump 16, and an electrical device 18. The support device 12 comprises a housing 20 which forms a receiving space 22. The electric motor 14, the pump 16 and at least some of the electrical device 18 are arranged in the receiving space 22.

When the high-pressure cleaning apparatus 10 is used as intended, a supply conduit 26 for supplying a cleaning liquid, in particular water, that is to be pressurized is connected to a pump inlet 24 of the pump 16. A high-pressure conduit 30, in the present case designed as a hose line 32, is connected to a pump outlet 28.

The high-pressure cleaning apparatus 10 has a user-guided operating unit 34 which, in the present example, is designed as a high-pressure gun 36. The operating unit 34 is connected to the hose line 32 and in this way is fluidically connected to the pump outlet 28. A release element 38 in the form of a hand-operated trigger 40 is arranged on the operating unit 34.

The supplied cleaning liquid is pressurized by the pump 16, for example an axial piston pump. When the hand-operated trigger 40 is actuated, a valve arranged in the operating unit 34 is opened so that the cleaning liquid can be sprayed via a spray lance 42 arranged on the operating unit 34.

The electrical device 18 comprises connection lines 44, 46 via which the device 18 and in particular the electric motor 14 are supplied with electrical energy. In the present case, a bipolar connection with two connection lines 44, 46 is provided. A connection with more than two poles could be provided, as already explained.

The electrical device 18 comprises a connection cable 48 having the connection line 44, 46 with a plug 50 for connecting to a power supply device 52, in particular a conventional power supply network.

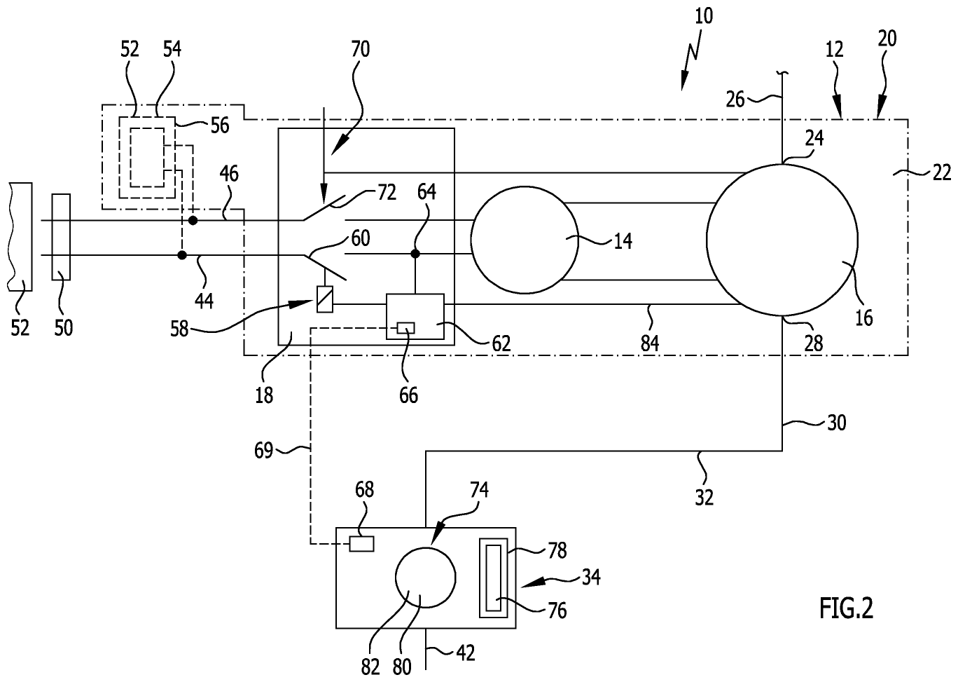

Alternatively or additionally, it can be provided that—shown by dashed lines in FIG. 2—the high-pressure cleaning apparatus 10 can be operated by means of at least one battery 54 as a power supply device 52. To accommodate the battery 54, the high-pressure cleaning apparatus 10 comprises a receptacle 56 formed, for example, by the housing 20. When arranged in the receptacle 56, the battery 54 is coupled to the connection lines 44, 46.

The electrical device 18 comprises a switching element 60 connected in the connection line 44, which switching element comprises a relay 58 in the present example. The relay 58 is operatively connected to a control unit 62 of the electrical device 18. The control unit 62 is galvanically isolated from the connection line 44 via the switching element 60.

The control unit 62 is also coupled via a connection 64 to the connection line 44 in order to detect a current flow therein and/or a voltage drop across the electric motor 14.

When the plug 50 is plugged in or the batteries 54 are inserted, voltage may be applied to the electrical device 18 and in particular to the control unit 62. A current flow can thereby be present, for example in the sense of a control current. However, as long as the connection line 44 is electrically interrupted via the switching element 60, no power current can flow to the electric motor 14.

The electrical device 18 comprises a first communication member 66, which the control unit 62 comprises, for example. The operating unit 34 comprises a second communication member 68, which second communication element is integrated, for example, into the actuating element 74 mentioned below.

The communication members 66, 68 are designed for wireless transmission of signals between the operating unit 34 and the control unit 62. In particular, a bidirectional radio connection 69 is thereby possible. For example, the use of a Bluetooth radio connection is conceivable.

The high-pressure cleaning apparatus 10 also has a pressure switch 70 with a switching element 72 which is connected in the connection line 46. Pressure of the cleaning liquid in the pump 16 can be detected via the pressure switch 70, for example in a pressure chamber to which the high-pressure conduit 30 is connected.

If the pressure is below a threshold pressure, the connection line 46 is electrically conductively connected. If the pressure is equal to the threshold pressure or higher, the connection line 46 is electrically interrupted.

The high-pressure cleaning apparatus 10 is free of an operating element for the user on the support device 12, for example the housing 20, via which operating element the connection lines 44, 46 can be electrically conductively connected or electrically interrupted. In comparison to conventional high-pressure cleaning apparatuses, no such “main switch” is provided for the user on the housing 20.

In order to switch the high-pressure cleaning apparatus 10 to standby mode in which it is ready for operation, the high-pressure cleaning apparatus 10 comprises an actuating element 74 on the operating unit 34. The actuating element 74 is electric and, for example, pressure-sensitive. Actuation is detected and a signal relating thereto can be transmitted from the communication member 68 to the communication member 66.

In a corresponding manner, by actuating the actuating element 74, a signal for switching off the high-pressure cleaning apparatus 10 is transmitted, in response to which the connection line 44 is electrically interrupted.

For supplying power to the actuating element 74, the operating unit 34 has at least one battery 76. The battery 76 is arranged, for example, in a lockable battery compartment 78 of the operating unit 34 and can be replaced if necessary. Alternatively or additionally, it can be provided that the battery 76 can be charged, in particular inside the operating unit 34.

The actuating element 74 comprises an indicating unit 80 of the high-pressure cleaning apparatus 10, which in the present case is configured as a display unit 82, preferably with a controllable image display.

The functionality of the high-pressure cleaning apparatus 10 shall be discussed below.

When used as intended, it is assumed, without limiting the present invention, that cleaning liquid is under pressure in the pump 16 following the preceding operation and the connection line 46 is electrically interrupted.

The user can first switch on the actuating element 74 if necessary.

Actuating the actuating element 74 makes it possible to transmit a switch-on signal to the control unit 62 via the communication members 66, 68. The control unit 62 electrically conductively connects the connection line 44 via the switching element 60 depending on the signal. This puts the high-pressure cleaning apparatus 10 into an operating mode in which a current flow to the electric motor 14 is possible.

In the operating mode, the high-pressure cleaning apparatus 10 is initially ready for operation, but the electric motor 14 has not yet started up. Only after actuating the hand-operated trigger 40, which is used to activate the operating unit 34, does the resulting pressure drop cause the pressure switch 70 to electrically conductively connect the connection line 46 via the switching element 72. The electric motor 14 is supplied with electrical energy to drive the pump 16. The user can spray the pressurized cleaning liquid.

If the hand-operated trigger 40 is no longer actuated and the operating unit 34 is locked, the resulting pressure rise leads to the pressure switch 70 responding and the connection line 46 being electrically interrupted via the switching element 72. However, the high-pressure cleaning apparatus 10 remains ready for operation so that the electric motor 14 starts again when the hand-operated trigger 40 is re-actuated.

If the pump 16 is initially depressurized when it is started up, the connection line 46 is initially electrically conductive. If the connection line 44 is electrically conductively connected depending on the actuation of the actuating element 74, current flows via the connection line 44 to the electric motor 14 so that the electric motor starts briefly. As long as the hand-operated trigger 40 is locked, pressure builds up in the pump 16 which causes an interruption of the connection line 46 via the pressure switch 70. The electric motor 14 starts again upon re-release via the hand-operated trigger 40.

During operation of the high-pressure cleaning apparatus 10, a current flow (power current) through the connection line 44 is monitored by the control unit 62 via the connection 64, for example. In the absence of a current flow, an indication thereof can be provided to the user on the display unit 82. For example, the indication comprises a fault message, since the control unit 62 assumes that no current is flowing despite the connection line 44 being conductively connected. The indication can, for example, comprise suggestions for remedying the fault.

During operation, the control unit 62 transmits test signals, preferably periodically, to the communication member 68 via the communication member 66. After receiving the test signal, a confirmation signal is returned. If there is no confirmation signal, the control unit 62 assumes that the radio connection 69 to the operating unit 34 is disturbed or interrupted.

After a predetermined number of unanswered test signals and/or after a predetermined period of time has elapsed, the control unit 62 can electrically interrupt the connection line 44 via the switching element 60 for safety reasons. For example, an interruption may occur after approximately 2 seconds to 30 seconds.

In the context of the present patent application, “predetermined” can in particular also include “predeterminable”.

Even when inactive, the control unit 62 can electrically interrupt the connection line 44. This occurs, for example, when the hand-operated trigger 40 is not actuated for a predetermined period of time. In practice, for example, approximately 10 minutes to 30 minutes of inactivity before the connection line 44 is interrupted may prove beneficial.

The interruption of the connection line 44 also offers the advantage that the electric motor 14 is not started up again in the event of any leakage in the high-pressure conduit 30 and/or the operating unit 34 and the associated pressure drop. This protects the electric motor 14 and the pump 16.

A control line 84 is shown in FIG. 2. The control unit 62 is electrically connected to a valve unit of the pump 16 via the control line 84. The valve unit is connected in a return line from the pressure chamber to the inlet chamber of the pump 16, the free cross-sectional area of which can be changed via the valve unit.

It is preferably possible to change the free cross-sectional area of the return line via the actuating element 74, in particular to regulate the pump pressure, without a separate adjusting element being required on the operating unit 34. The return line and the valve unit as well as their control can be configured as described in the international application of the same applicant published under WO 2016/102074 A1, for example.

### LIST OF REFERENCE NUMERALS

10 High-pressure cleaning apparatus
12 Support apparatus
14 Electric motor
16 Pump
18 Electrical device
20 Housing
22 Receiving space
24 Pump inlet
26 Supply conduit
28 Pump outlet
30 High-pressure conduit
32 Hose line
34 Operating unit
36 High-pressure gun
38 Release element
40 Hand-operated trigger
42 Spray lance
44 Connection line
46 Connection line
48 Connection cable
50 Plug
52 Power supply device
54 Battery
56 Receptacle
58 Relay
60 Switching element
62 Control unit
64 Connection
66, 68 Communication member
69 Radio connection
70 Pressure switch
72 Switching element
74 Actuating element
76 Battery
78 Battery compartment
80 Indicating unit
82 Display unit
84 Control line

1. An electrically operated high-pressure cleaning apparatus, comprising
a support device, an electric motor held thereon and/or arranged thereon, a pump which is drivable by the electric motor and an electrical device,
as well as a user-guided operating unit which is connected or connectable to the pump via a high-pressure conduit,
the electrical device comprising two connection lines via which the electric motor is connected or connectable to a power supply device in a bipolar manner and is suppliable with electrical energy,
wherein the electrical device comprises at least one switching element connected in at least one connection line, a control unit, and a first communication member,
wherein the operating unit comprises an actuating element and a second communication member for wirelessly transmitting a signal to the first communication member,
and wherein the control unit is operatively connected to the at least one switching element and the at least one connection line is electrically conductively connected or electrically interrupted depending on the actuation of the actuating element.

2. The high-pressure cleaning apparatus in accordance with claim 1, wherein the high-pressure cleaning apparatus is switched to a standby mode when the connection line is electrically conductively connected, the electric motor being switched on only when the user actuates a release element on the operating unit for spraying the cleaning liquid.

3. The high-pressure cleaning apparatus in accordance with claim 1, wherein a permanent radio connection between the communication members is provided after the at least one connection line has been electrically conductively connected for the first time by actuating the actuating element and until the at least one connection line is electrically interrupted by actuating the actuating element.

4. The high-pressure cleaning apparatus in accordance with claim 1, wherein the electrical device does not comprise a further switching element connected in the at least one connection line.

5. The high-pressure cleaning apparatus in accordance with claim 1, wherein the high-pressure cleaning apparatus is void of an operating element on the support device for the user as a component of the electrical device in order to electrically conductively connect the at least one connection line, and/or, apart from the actuating element, the high-pressure cleaning apparatus does not comprise a further operating element for switching on and/or switching off the high-pressure cleaning apparatus.

6. The high-pressure cleaning apparatus in accordance with claim 1, wherein the control unit is galvanically isolated from the at least one connection line via the switching element.

7. The high-pressure cleaning apparatus in accordance with claim 1, wherein the signal transmitted from the second communication member to the first communication member is a pulse signal.

8. The high-pressure cleaning apparatus in accordance with claim 1, wherein at least one of the following applies during operation of the high-pressure cleaning apparatus:
the electrically conductively connected connection line is monitorable by the control unit for a current flow to the electric motor and/or a voltage drop across the electric motor, an indication of the absence of a current flow and/or of a voltage drop being provided to the user at an indicating unit of the high-pressure cleaning apparatus;
the high-pressure cleaning apparatus is monitorable for the occurrence of a drop in pressure in the cleaning liquid, an indication of a pressure drop being providable to the user on an indicating unit of the high-pressure cleaning apparatus, should a pressure drop occur.

9. The high-pressure cleaning apparatus in accordance with claim 8, wherein the indicating unit is a display unit.

10. The high-pressure cleaning apparatus in accordance with claim 8, wherein the operating unit comprises or forms the indicating unit and a corresponding indication signal is transmissible from the first communication member to the second communication member.

11. The high-pressure cleaning apparatus in accordance with claim 1, wherein a test signal is transmissible from the control unit via the first communication member to the second communication member when at least one connection line is electrically conductively connected and a confirmation signal in response to the test signal is transmissible from the second communication member to the first communication member, in the absence of which the at least one connection line is electrically interrupted.

12. The high-pressure cleaning apparatus in accordance with claim 1, wherein the test signal is repeatedly transmissible, the connection line being interrupted only after a predetermined number of absent confirmation signals or after a predetermined period of time has elapsed.

13. The high-pressure cleaning apparatus in accordance with claim 12, wherein the test signal is periodically transmissible.

14. The high-pressure cleaning apparatus in accordance with claim 1, wherein the operating unit comprises at least one battery for supplying power to the actuating element.

15. The high-pressure cleaning apparatus in accordance with claim 14, wherein a charge level of the at least one battery is displayable on a a display unit, and/or an indication is providable when the at least one battery falls below a predetermined charge level.

16. The high-pressure cleaning apparatus in accordance with either claim 12, wherein, when the actuating element is actuated, no signal is transmitted from the second communication member to the first communication member if the at least one battery falls below a predetermined charge level.

17. The high-pressure cleaning apparatus in accordance with claim 1, wherein the operating unit comprises a release element via which the operating unit is activatable for spraying the cleaning liquid, the release element being different from the actuating element.

18. The high-pressure cleaning apparatus in accordance with claim 17, wherein the release element is a hand-operated trigger.

19. The high-pressure cleaning apparatus in accordance with claim 1, wherein the control unit electrically interrupts the at least one connection line via the at least one switching element when at least one of the following is fulfilled:
after a predetermined period of time has elapsed within which the release element has not been actuated;
after a predetermined period of time has elapsed within which no current flow through the at least one connection line has been detected.

20. The high-pressure cleaning apparatus in accordance with claim 1, wherein the high-pressure cleaning apparatus comprises a pressure switch by means of which pressure in the pump or downstream of the pump is detectable, the pressure switch comprising or being operatively connected to a further switching element which is connected in one of the connection lines, and the further switching element electrically conductively connects the connection line when the pressure falls below a threshold pressure, and interrupts said connection line when the pressure reaches and/or exceeds the threshold pressure.

21. The high-pressure cleaning apparatus in accordance with claim 1, wherein the further switching element is connected in a different connection line than the switching element which is actuated depending on the actuation of the actuating element.

22. The high-pressure cleaning apparatus in accordance with claim 1, wherein the high-pressure cleaning apparatus is wired and has a connection cable comprising the connection lines, and/or the high-pressure cleaning apparatus is battery-operated and has a receptacle for an electric battery which is couplable to the connection lines.

23. The high-pressure cleaning apparatus in accordance with claim 1, wherein the support device comprises a housing of the high-pressure cleaning apparatus in which the electric motor, the pump and, at least in part, the electrical device are accommodated.
